(19) United States
(12) Patent Application Publication
(10) Pub. No.: US 2026/0341694 A1
(43) Pub. Date: Oct. 29, 2026

(54) PRECURSOR FOR POSITIVE ELECTRODE ACTIVE MATERIAL FOR LITHIUM SECONDARY BATTERY, POSITIVE ELECTRODE ACTIVE MATERIAL DERIVED FROM SAME, AND METHOD FOR MANUFACTURING POSITIVE ACTIVE MATERIAL

(71) Applicant: POSCO FUTURE M CO., LTD., Pohang-si (KR)

(72) Inventors: Seung Un CHOI, Gumi-si (KR); Gyeong Won NAM, Gumi-si (KR); Kwang Eun JUNG, Gumi-si (KR); Do Gak JEUNG, Gumi-si (KR); Jeong Han KIM, Gumi-si (KR); Chang Hyun LEE, Gumi-si (KR)

(21) Appl. No.: 19/103,602

(22) PCT Filed: Aug. 16, 2023
(86) PCT No.: PCT/KR2023/012070

§ 371 Date: Feb. 13, 2025

(30) Foreign Application Priority Data
Aug. 16, 2022 (KR) 10-2022-0102058

(51) Int. Cl. H01M 4/525; C01G 53/502

(52) U.S. Cl. CPC H01M 4/525; C01G 53/502; C01P 2002/70; C01P 2002/72; C01P 2004/61

(57) ABSTRACT

The present disclosure relates to a positive electrode active material precursor for a lithium secondary battery, a positive electrode active material for a lithium secondary battery, and a method of producing a positive electrode active material. Controlling an ionic environment during a coprecipitation process to form the precursor, then sintering yields a positive electrode active material having an improved single crystal particle morphology that imparts improved stability, capacity and lifetime characteristics to lithium secondary batteries constructed therefrom. X-ray crystallography indicates that improved positive electrode active material precursor materials have been grown by forming hydrogen bonds in a <001> direction.

### CROSS-REFERENCE TO RELATED APPLICATION

This application is a National Stage Entry of International Patent Application No. PCT/KR2023/012070, filed on Aug. 16, 2023, which claims priority from and the benefit of Korean Patent Application No. 10-2022-0102058, filed on Aug. 16, 2022, which is hereby incorporated by reference for all purposes as if fully set forth herein.

### FIELD OF THE INVENTION

Embodiments of the invention relate generally to a secondary battery, and more particularly, to a positive electrode active material precursor for a lithium secondary battery, a positive electrode active material for a lithium secondary battery derived from the same, and a method of producing the same.

### BACKGROUND

In general, a lithium secondary battery includes a positive electrode including a positive electrode active material, a negative electrode including a negative electrode active material, a separator, and an electrolyte. Charging and discharging of the lithium secondary battery are performed with intercalation and deintercalation of lithium ions into and out of the electrode active materials. The lithium secondary battery has advantages including a high energy density, a high electromotive force, and a high capacity, and thus has been found useful in various fields.

In addition, improvement of high-temperature performance, such as high-temperature storage characteristics and high-temperature cycle characteristics, is an important object in the lithium secondary battery industry. For example, if total internal pore volume in a positive electrode active material is high after applying the positive electrode active material to a current collector, typically a metal foil, and performing rolling by passing the coated current collector through a series of rollers to form a compacted positive electrode active material, the high-temperature performance of the positive electrode is likely to be degraded in comparison with the high temperature performance characteristic of a positive electrode active material having a more moderate internal pore volume and in comparison with the high temperature performance characteristic inherent in the crystalline positive electrode active material prior to crushing in the rolling step. Therefore, there is a need for improving high-temperature performance characteristics in a positive electrode active material for a lithium secondary battery, such as a rapid charging secondary battery, by minimizing the changes in electrode structure and total internal pore volume that occur in the positive electrode active material during electrode rolling.

In addition, in accordance with improvements in technology and increased demand for mobile devices, demand for a secondary battery as an energy source has rapidly increased. Among these secondary batteries, lithium secondary batteries that exhibit high energy density and high operating potential and have a long cycle lifespan and a low self-discharge rate have been commercialized and widely used.

In addition, in accordance with an increase in interest in environmental issues, interest in electric vehicles and hybrid electric vehicles that may replace vehicles using fossil fuels, such as gasoline vehicles and diesel vehicles, which are one of the main causes of air pollution, has increased. Studies of using a lithium secondary battery as a power source for electric vehicles and hybrid electric vehicles have been actively pursued.

In accordance with improvement in technology and increased demand for electric vehicles, demand for a lithium secondary battery as an energy source for use on the large scale required for automotive propulsion has rapidly increased. Specifically, interest in a lithium nickel cobalt manganese composite oxide as a positive electrode active material for a lithium secondary battery has rapidly increased, and, in the composite oxide in particular, cobalt plays an important role in providing a positive electrode active material having a high operating voltage and excellent efficiency characteristics.

However, cobalt has limitations in its mass use in power sources for electric vehicles because it is expensive, and, as the price of cobalt has recently risen rapidly and the content of cobalt in electrode active materials of lithium secondary batteries has consequently gradually been decreasing, new solutions are required to complement the stability and lifespan of positive electrode active materials used in lithium secondary batteries.

In addition, as a method for improving the stability of the positive electrode active material, a lithium transition metal oxide having a concentration gradient in which a concentration of transition metal components gradually changes from the surface to the inside of the positive electrode active material particle has been proposed. However, in these materials, internal cracks arise in particles during charging and discharging processes, and this cracking currently cannot be completely controlled. Also, a complex process is used to form a transition metal gradient in an electrode active material, requiring high processing costs and making quality control difficult.

There is thus a need in the art for an improved positive electrode active material that provides superior high temperature storage and cycling performance by maintaining its crystalline structure better through the rolling process, that provides for improved stability, battery lifespan and efficiency while allowing for high operating voltages and decreased cobalt levels and that keeps processing costs low and quality control high with a homogeneous positive electrode active material composition.

The above information disclosed in this Background section is only for understanding of the background of the inventive concepts, and, therefore, it may contain information that does not constitute prior art.

### SUMMARY

The present invention meets these goals by providing a new positive electrode active material that is easily prepared using a simple coprecipitation and sintering process. The present disclosure provides a positive electrode active material precursor with the advantages of having low processing costs and easy quality control in the processing of a positive electrode active material therefrom. The positive electrode active material is imbued with improved stability and lifespan characteristics because its homogeneous composition limits internal cracks of particles that can occur during charging and discharging processes, these being particularly troublesome in alternative positive electrode active materials featuring transition metal concentration gradients. An improved single crystalline particle morphology in the inventive positive electrode active materials provides corresponding lithium secondary batteries with improved capacity and lifetime characteristics. Also, the inventive positive electrode active materials feature an optimal particle size distribution that provides ease of handling and production economy and provides batteries constructed therefrom with good charging and discharging efficiency.

In one aspect, the present invention provides a positive electrode active material precursor, wherein the positive electrode active material precursor comprises nickel, cobalt, manganese and oxygen atoms, wherein the positive electrode active material precursor satisfies, in X-ray diffraction (XRD) peak values, at least one of an I₀₀₁/I₁₀₀ ratio of 0.5 to 6, an I₀₀₁/I₁₀₁ ratio of 0.6 to 3, an I₀₀₁/I₁₀₂ ratio of 2.5 to 8, an I₀₀₁/I₁₁₀ ratio of 1.5 to 11, an I₀₀₁/I₁₁₁ ratio of 2 to 14, an I₁₀₀/I₀₀₁ ratio of 0.1 to 3.1, an I₁₀₀/I₁₀₁ ratio of 0.1 to 1.5, an I₁₀₀/I₁₀₂ ratio of 1.0 to 7.3, an I₁₀₀/I₁₁₀ ratio of 1.5 to 3.2, and an I₁₀₀/I₁₁₁ ratio of 2.5 to 5.3, and wherein, in the XRD peak values, I₀₀₁ is a peak intensity value within a diffraction range of 18.5+/−1.0°, I₁₀₀ is a peak intensity value within a diffraction range of 33.0+/−1.0°, I₁₀₁ is a peak intensity value within a diffraction range of 38.5+/−1.5°, I₁₀₂ is a peak intensity value within a diffraction range of 52.5 +/−1.5°, I₁₁₀ is a peak intensity value within a diffraction range of 59+/−1.5°, and I₁₁₁ is a peak intensity value within a diffraction range of 63+/−1.0°. In an embodiment, the positive electrode active material precursor may satisfy at least one of a full width at half maximum of a diffraction peak on a (001) plane of 0.1 to 3.0 degrees, a full width at half maximum of a diffraction peak on a (100) plane of 0.1 to 2.8 degrees, a full width at half maximum of a diffraction peak on a (101) plane of 0.36 to 1.0 degrees, a full width at half maximum of a diffraction peak on a (102) plane of 0.1 to 2.0 degrees, and a full width at half maximum of a diffraction peak on a (110) plane of 0.1 to 3.0 degrees.

In an embodiment, the positive electrode active material precursor can have a structure in which at least one or more layers of a transition metal layer and an oxygen layer are stacked. In some embodiments, the transition metal layer and the oxygen layer can form a stacked aggregate through hydrogen bonds. In some embodiments, the positive electrode active material precursor can include at least one or more primary particles, and a lattice constant value of a c-axis of the at least one or more primary particles can be 300 nm to 700 nm.

In some embodiments, the inventive positive electrode active precursor can satisfy, in XRD peak values, at least two of an I₀₀₁/I₁₀₀ ratio of 0.5 to 6, an I₀₀₁/I₁₀₁ ratio of 0.6 to 3, an I₀₀₁/I₁₀₂ ratio of 2.5 to 8, an I₀₀₁/I₁₁₀ ratio of 1.5 to 11, an I₀₀₁/I₁₁₁ ratio of 2 to 14, an I₁₀₀/I₀₀₁ ratio of 0.1 to 3.1, an I₁₀₀/I₁₀₁ ratio of 0.1 to 1.5, an I₁₀₀/I₁₀₂ ratio of 1.0 to 7.3, an I₁₀₀/I₁₁₀ ratio of 1.5 to 3.2, and an I₁₀₀/I₁₁₁ ratio of 2.5 to 5.3.

In some embodiments, the inventive positive electrode active precursor can satisfy, in XRD peak values, each of an I₀₀₁/I₁₀₀ ratio of 0.5 to 6, an I₀₀₁/I₁₀₁ ratio of 0.6 to 3, an I₀₀₁/I₁₀₂ ratio of 2.5 to 8, an I₀₀₁/I₁₁₀ ratio of 1.5 to 11, an I₀₀₁/I₁₁₁ ratio of 2 to 14, an I₁₀₀/I₀₀₁ ratio of 0.1 to 3.1, an I₁₀₀/I₁₀₁ ratio of 0.1 to 1.5, an I₁₀₀/I₁₀₂ ratio of 1.0 to 7.3, an I₁₀₀/I₁₁₀ ratio of 1.5 to 3.2, and an I₁₀₀/I₁₁₁ ratio of 2.5 to 5.3.

In another aspect, the present invention provides a positive electrode active material prepared by sintering at least one or more positive electrode active material precursors having hydrogen bonds in a <001> direction, wherein the positive electrode active material can be a single particle containing, by wt %, 500 to 2,000 ppm of Li₂CO₃. In an embodiment, the positive electrode active material can further contain LiOH, and LiOH and Li₂CO₃ may satisfy the following Expression 1:

0.5≤[LiOH]/[Li₂CO₃]≤1.9 <Expression 1>
wherein [LiOH] represents a content of LiOH, [Li₂CO₃] represents a content of Li₂CO₃ and [LiOH]/[Li₂CO₃] represents a molar ratio of LiOH to Li₂CO₃.

In some embodiments, LiOH can be contained in the positive electrode active material in an amount of about 1,000 to about 4,000 ppm in terms of wt %. In some embodiments, a median particle diameter (D50) of the positive electrode active material can be in a range from about 2 to about 20 μm.

In certain embodiments, a specific surface area of the positive electrode active material can be in a range from about 1 to about 30 m²/g. In some embodiments, the positive electrode active material may be a lithium-nickel composite oxide represented by the following Chemical Formula 1:

Liₓ[Ni_{y}CO_{z}Mn_{w}Mᵥ]O₂ <Chemical Formula 1>
wherein M is one or more selected from Ba, Ca, Zr, Ti, Mg, Ta, Nb, and Mo, and wherein 0.9<x<1.2, 0.8<y<1, 0<z<0.8, 0<w<0.05, and 0≤v≤0.2.

In another aspect, the present invention provides a method for producing a positive electrode active material, the method comprising charging a reactor vessel with an aqueous solution containing a sodium or potassium-based material in a concentration of 5 to 10 parts by weight with respect to 100 parts by weight of water; adding a) a metal salt aqueous solution containing at least one or more of nickel, cobalt, and manganese, b) a complex ion forming agent, and c) a pH adjuster to the reactor vessel to prepare a reaction solution; filtering the reaction solution to provide a solid metal composite hydroxide; mixing the solid metal composite hydroxide and a lithium raw material to yield a positive electrode active material precursor; and sintering the positive electrode active material precursor.

In some embodiments, the sodium or potassium-based material can include at least one of sodium sulfate, sodium chlorate, potassium chlorate, and potassium sulfate. In some embodiments, in the adding step, the metal salt aqueous solution containing at least one or more of nickel, cobalt, and manganese, the complex ion forming agent and the pH adjuster can be added in separate streams to the reactor vessel, a total metal sulfate concentration in the metal salt aqueous solution can be about 2.5M, the complex forming agent can be ammonia and the ammonia can be added to the reactor vessel as a 28% ammonia water solution, and a ratio of a flow rate of ammonia water to a flow rate of the metal salt aqueous solution can be about 0.06 to about 0.3.

In some embodiments, the flow rate of the metal salt aqueous solution can be in a range of about 2.5 to about 3.5 L/hr. In some embodiments, the sintering can be performed in a temperature range of about 750 to about 1,100 °C. In some embodiments, the sintering can be performed for about 5 to about 30 hours. In some embodiments, in the adding step of the above method, the pH adjuster can be added to the reactor vessel at a rate allowing a pH in the reactor vessel to be controlled to a range of 10 to 12.

According to some embodiments of the present disclosure, there can be provided a positive electrode active material precursor grown by forming hydrogen bonds in a <001> direction.

According to some embodiments of the present disclosure, there can be provided a positive electrode active material that has improved stability and lifespan characteristics and has a content of residual Li₂CO₃ that can be limited to more than a customary extent, and therefore cracks occurring at polycrystalline boundaries can be reduced when a single particle prepared from the precursor having the advantages described above is formed.

According to still other embodiments of the present disclosure, there is provided a method of producing a positive electrode active material having the advantages described above by controlling a concentration of the complex ion forming agent in the reactor vessel during the adding step of the above described method for producing a positive electrode active material.

Additional features of the inventive concepts will be set forth in the description which follows, and in part will be apparent from the description, or may be learned by practice of the inventive concepts.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIGS. 1A, 1B and 1C illustrate scanning electron micrograph (SEM) photographs of positive electrode active material precursors according to examples and comparative examples of the present disclosure.

FIG. 2 illustrates XRD peak intensity values according to examples and comparative examples of the present disclosure.

FIGS. 3A, 3B and 3C illustrate SEM photographs obtained by imaging positive electrode active materials for a lithium secondary battery according to examples and comparative examples of the present disclosure.

FIGS. 4A and 4B are graphs showing capacity characteristics and lifespan characteristics of the positive electrode active materials for a lithium secondary battery according to examples and comparative examples of the present disclosure.

FIG. 5 illustrates an SEM photograph of an active material precursor for a lithium secondary battery constructed in a comparative example of the present disclosure from a positive electrode active material obtained by initially adding an aqueous ammonium sulfate solution to a reactor vessel to begin a preparative procedure.

### DETAILED DESCRIPTION

Applicants have unexpectedly found a simple way to improve upon conventional coprecipitation methods of producing a nickel cobalt manganese (NCM) positive electrode active material precursor for a lithium secondary battery. Applicants have discovered that the ionic aqueous solution environment in which the precursor precipitate is formed can profoundly affect the particle morphology of these crystalline materials. When streams of a solution of the metal salts, a solution of a complexing agent such as ammonia and a pH adjusting titrant such as lithium hydroxide are simultaneously added to an initial aqueous sodium or potassium salt solution of the proper concentration, the primary particles of the subsequently formed precursor materials are notably larger and thicker in comparison with precursor material particles prepared using water or an ammonium salt as the initial aqueous solution. Sintering the improved positive electrode active material precursors forms improved positive electrode active materials. The improved positive electrode active materials show a more uniform, single crystalline particle structure, and lithium secondary batteries constructed with them show improved capacity and lifetime characteristics.

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Terminologies used herein are to mention only a specific embodiment, and are not to limit the present disclosure. Singular forms used herein include plural forms as long as phrases do not clearly indicate an opposite meaning. The term “comprising” used in the specification concretely indicates specific properties, regions, integers, steps, operations, elements, and/or components, and is not to exclude the presence or addition of other specific properties, regions, integers, steps, operations, elements, and/or components.

Hereinafter, embodiments of the present disclosure will be described in detail. However, these embodiments are provided as examples, and the present disclosure is not limited by these embodiments and is defined by only the scope of the claims to be described below.

### X-Ray Crystallography of Positive Electrode Active Material Precursors

According to an embodiment of the present disclosure, a positive electrode active material precursor for a lithium secondary battery may satisfy, in XRD peak values, at least one of an I₀₀₁/I₁₀₀ ratio of 0.5 to 6, an I₀₀₁/I₁₀₁ ratio of 0.6 to 3, an I₀₀₁/I₁₀₂ ratio of 2.5 to 8, an I₀₀₁/I₁₁₀ ratio of 1.5 to 11, an I₀₀₁/I₁₁₁ ratio of 2 to 14, an I₁₀₀/I₀₀₁ ratio of 0.1 to 3.1, an I₁₀₀/I₁₀₁ ratio of 0.1 to 1.5, an I₁₀₀/I₁₀₂ ratio of 1.0 to 7.3, an I₁₀₀/I₁₁₀ ratio of 1.5 to 3.2, and an I₁₀₀/I₁₁₁ ratio of 2.5 to 5.3. Specifically, I₀₀₁ can be a peak intensity value within a diffraction range of 18.5±1.0° in the XRD peak values. More specifically, I₀₀₁ can refer to a C-axis growth precursor grown by forming hydrogen bonds.

I₁₀₀ can be a peak intensity value within a diffraction range of 33.0±1.0° in the XRD peak values, and I₁₀₁ can be a peak intensity value within a diffraction range of 38.5±1.5° in the XRD peak values, which can refer to a peak value of an A-axis growth precursor.

I₁₀₂ can be a peak intensity value within a diffraction range of 52.5±1.5° in the XRD peak values, I₁₁₀ can be a peak intensity value within a diffraction range of 59±1.5° in the XRD peak values, and I₁₁₁ can be a peak intensity value within a diffraction range of 63±1.0° in the XRD peak values.

The I₀₀₁/I₁₀₀ ratio is one of the indicators for determining a precursor grown by forming hydrogen bonds in a 001 direction, and a higher I₀₀₁/I₁₀₀ ratio indicates a precursor grown to a greater extent by forming hydrogen bonds in the 001 direction. The I₀₀₁/I₁₀₀ ratio can be 0.5 to 6. Specifically, the I₀₀₁/I₁₀₀ ratio can be 2 to 6. More specifically, the I₀₀₁/I₁₀₀ ratio can be 2.3 to 4.4.

When the I₀₀₁/I₁₀₀ ratio falls within the range described above, a single particle of the positive electrode active material can be obtained according to precursor sintering. When the ratio exceeds the upper limit value, there is a problem with capacity in a battery constructed with the material, and when the ratio falls below the lower limit value, there is a problem with difficulty in forming a single particle of the positive electrode active material.

The I₀₀₁/I₁₀₁ ratio is one of the indicators for determining a precursor grown by forming hydrogen bonds in the 001 direction, and a higher I₀₀₁/I₁₀₁ ratio indicates a precursor grown to a greater extent by forming hydrogen bonds in the 001 direction. The I₀₀₁/I₁₀₁ ratio can be 0.6 to 3. Specifically, the I₀₀₁/I₁₀₁ ratio can be 1.5 to 3. More specifically, the I₀₀₁/I₁₀₁ ratio can be 1.5 to 1.8.

When the I₀₀₁/I₁₀₁ ratio falls within the range described above, cracks occurring at polycrystalline boundaries are reduced, such that stability and lifespan characteristics are improved, and a content of residual Li₂CO₃ is limited. When the ratio exceeds the upper limit value, there is a problem with capacity in a battery constructed with the material, and when the ratio falls below the lower limit value, there is a problem in that the size of the primary particle decreases and the boundary area of the crystal plane increases, resulting in an increase in cracks.

The I₀₀₁/I₁₀₂ ratio is one of the indicators for determining a precursor grown by forming hydrogen bonds in the 001 direction, and a higher I₀₀₁/I₁₀₂ ratio indicates a precursor grown to a greater extent by forming hydrogen bonds in the 001 direction. The I₀₀₁/I₁₀₂ ratio can be 2.5 to 8. Specifically, the I₀₀₁/I₁₀₂ ratio can be 4.9 to 6.7.

When the I₀₀₁/I₁₀₂ ratio falls within the range described above, a single particle of the positive electrode active material can be obtained by precursor sintering. When the ratio exceeds the upper limit value, there is a problem with capacity in a battery constructed with the material, and when the ratio falls below the lower limit value, there is a problem with difficulty in forming a single particle of the positive electrode active material.

The I₀₀₁/I₁₁₀ ratio is one of the indicators for determining a precursor grown by forming hydrogen bonds in the 001 direction, and a higher I₀₀₁/I₁₁₀ ratio indicates a precursor grown to a greater extent by forming hydrogen bonds in the 001 direction. The I₀₀₁/I₁₁₀ ratio can be 1.5 to 11. Specifically, the I₀₀₁/I₁₁₀ ratio can be 4.0 to 10.5. More specifically, the I₀₀₁/I₁₁₀ ratio can be 4.2 to 10.3.

When the I₀₀₁/I₁₁₀ ratio falls within the range described above, a single particle of the positive electrode active material can be obtained by precursor sintering. When the ratio exceeds the upper limit value, there is a problem with capacity in a battery constructed with the material, and when the ratio falls below the lower limit value, there is a problem with difficulty in forming a single particle of the positive electrode active material.

The I₀₀₁/I₁₁₁ ratio is one of the indicators for determining a precursor grown by forming hydrogen bonds in the 001 direction, and a higher I₀₀₁/I₁₁₁ ratio indicates a precursor grown to a greater extent by forming hydrogen bonds in the 001 direction. The I₀₀₁/I₁₁₁ ratio can be 2 to 14. Specifically, the I₀₀₁/I₁₁₁ ratio can be 7.0 to 13.5. More specifically, the I₀₀₁/I₁₁₁ ratio can be 7.4 to 13.0.

When the I₀₀₁/I₁₁₁ ratio falls within the range described above, a single particle of the positive electrode active material can be obtained by precursor sintering. When the ratio exceeds the upper limit value, there is a problem with capacity in a battery constructed with the material, and when the ratio falls below the lower limit value, there is a problem with difficulty in forming a single particle of the positive electrode active material.

In an embodiment, the I₁₀₀/I₀₀₁ ratio can fall within a range of 0.1 to 3.1. Specifically, the I₁₀₀/I₀₀₁ ratio can fall within a range of 0.23 to 0.44. The I₁₀₀/I₁₀₁ ratio can fall within a range of 0.1 to 1.5. Specifically, the I₁₀₀/I₁₀₁ ratio can fall within a range of 0.34 to 0.78.

In an embodiment, the I₁₀₀/I₁₀₂ ratio can fall within a range of 1.0 to 7.3. Specifically, the I₁₀₀/I₁₀₂ ratio can fall within a range of 1.13 to 2.95. In an embodiment, the I₁₀₀/I₁₁₀ ratio can fall within a range of 1.5 to 3.2. Specifically, the I₁₀₀/I₁₁₀ ratio can fall within a range of 1.83 to 2.37. In an embodiment, the I₁₀₀/I₁₁₁ ratio can fall within a range of 2.5 to 5.3. Specifically, the I₁₀₀/I₁₁₁ ratio can fall within a range of 2.98 to 3.28. When the I₁₀₀/I₀₀₁ ratio, the I₁₀₀/I₁₀₁ ratio, the I₁₀₀/I₁₀₂ ratio, the I₁₀₀/I₁₁₀ ratio, or the I₁₀₀/I₁₁₁ ratio in the XRD spectrum of the precursor falls within the corresponding range described above, a single particle is easily obtained when a positive electrode active material is produced.

In an embodiment, the positive electrode active material precursor can satisfy at least one of a full width at half maximum (FWHM) of a diffraction peak on a (001) plane of 0.1 to 3.0 degrees, a full width at half maximum of a diffraction peak on a (100) plane of 0.1 to 2.8 degrees, a full width at half maximum of a diffraction peak on a (101) plane of 0.36 to 1.0 degrees, a full width at half maximum of a diffraction peak on a (102) plane of 0.1 to 2.0 degrees, and a full width at half maximum of a diffraction peak on a (110) plane of 0.1 to 3.0 degrees.

Specifically, the full width at half maximum (FWHM) may satisfy at least one of a full width at half maximum of a diffraction peak on a (001) plane of 0.27 to 0.42 degrees, a full width at half maximum of a diffraction peak on a (100) plane of 0.21 to 0.34 degrees, a full width at half maximum of a diffraction peak on a (101) plane of 0.37 to 0.55 degrees, a full width at half maximum of a diffraction peak on a (102) plane of 0.56 to 1.03 degrees, and a full width at half maximum of a diffraction peak on a (110) plane of 0.33 to 0.66 degrees.

### Positive Electrode Active Material Precursor Structure

In an embodiment, the positive electrode active material precursor may have a structure in which at least one or more layers of a transition metal layer and an oxygen layer are stacked. The transition metal layer may be formed of nickel, cobalt, manganese, or a mixture thereof. The transition metal layer may be stacked through hydrogen bonds with the oxygen layer to form a dense aggregate. The dense aggregate plays a role in advantageously forming a single particle during a sintering process in a process of producing a positive electrode active material as described below.

In an embodiment, the positive electrode active material precursor can include at least one or more primary particles, and the primary particle can have a c-axis value of 300 nm to 700 nm. Specifically, as the positive electrode active material precursor reduces the dissolution of the transition metal layer and the electrostatic repulsion of the (001) plane, the primary particles constituting the positive electrode active material precursor can be formed relatively thick and large, such that a single particle may be formed even at a relatively low temperature during the synthesis of the positive electrode active material.

In an embodiment, a Span value ((D90−D10)/D50), which is a ratio of a difference between a D90 particle diameter and a D10 particle diameter to a D50 particle diameter, of the positive electrode active material precursor can fall within a range of 0.55 to 0.75. Specifically, the Span value can fall within a range of 0.55 to 0.70, and more specifically, a range of 0.61 to 0.67.

The D10, D50, and D90 particle diameters refer to the particle sizes when 10%, 50%, or 90%, respectively, of precursor particles are smaller than these diameters. In a case where the Span value exceeds the upper limit value of the above range, when considered for particles of a positive electrode active material in a battery, the total specific surface area is relatively large because a wider size distribution corresponds to more smaller particles that contribute to a larger total surface area, but less particle size uniformity results in lower initial charge and discharge efficiency because intercalation/deintercalation of lithium ions can occur at a slower diffusion rate and because uneven stress distribution can lead to cracking. When the Span value falls below the lower limit value of the above range, a production yield for industrially processing powder having a significantly small particle diameter variation decreases significantly due to a need to remove particles having either size extreme, resulting in an increase in costs.

### Positive Electrode Active Materials

In some embodiments of the present disclosure, the positive electrode active material for a lithium secondary battery can be formed by sintering at least one or more positive electrode active material precursors having hydrogen bonds in the <001> direction. For a detailed description of the positive electrode active material precursor, reference may be made to the above description to the extent that it is not contradictory.

In an embodiment, the positive electrode active material for a lithium secondary battery can be a single particle containing, by wt %, 500 to 2,000 ppm of Li₂CO₃. Specifically, the content of Li₂CO₃ can be 800 to 1,800 ppm. When the content of Li₂CO₃ is within the above range, residual lithium is reduced. When the content range of Li₂CO₃ exceeds the upper limit value, lifespan characteristics are deteriorated and instability increases.

Single particle morphology in this context is defined by a positive electrode active material in which the entirety of the primary particles are single-crystallized and there is no distinction between the primary particle, which is the primary structure of the single particle, and the secondary particle, which is an aggregate in which a plurality of primary particles are aggregated by physical or chemical bonding between the primary particles. When the positive electrode active material for a lithium secondary battery has the single particle shape, cracks occurring at polycrystalline boundaries are reduced, such that a positive electrode active material having excellent stability and lifespan characteristics can be provided.

In some embodiments, the positive electrode active material for a lithium secondary battery can contain LiOH and can satisfy the following Expression 1:

0.5≤[LiOH]/[Li₂CO₃]≤1.9 <Expression 1>
wherein [LiOH] represents a content of LiOH and [Li₂CO₃] represents a content of Li₂CO₃ and [LiOH]/[Li₂CO₃] represents a molar ratio of LiOH to Li₂CO₃.

Expression 1 can specify a range of 0.5 to 1.9. Specifically, Expression 1 can specify a range of 1.1 to 1.75.

When a molar ratio of the content of lithium hydroxide (LiOH) to the content of lithium carbonate (Li₂CO₃) falls within the above range, the resistance of the active material can be reduced, and the stability and lifespan characteristics of the active material can be improved. When the range of Expression 1 exceeds the upper limit value of the above range, instability increases, and lifespan characteristics are deteriorated.

In some embodiments, LiOH can be contained in the inventive positive electrode active material in an amount of from 1,000 to 4,000 ppm in terms of wt %. Specifically, LiOH can be contained in an amount of from 1,400 to 2,000 ppm in terms of wt %. When the content of LiOH is within the above range, residual LiOH in the positive electrode active material is limited, and gas generation is reduced. When the content of LiOH exceeds the above upper limit value, instability increases due to an increase in gas generation.

In an embodiment, a median particle diameter (D50) of the positive electrode active material for a lithium secondary battery can be in a range from about 2.0 to about 20 μm. Specifically, the median particle diameter (D50) can be in a range from about 3.6 to about 4.4 μm. More specifically, the median particle diameter (D50) may be in a range from about 3.80 to about 4.06 μm.

When the median particle diameter (D50) exceeds the upper limit value, the total internal pore volume after rolling is high. When the median particle diameter (D50) falls below the lower limit value, there is a stability problem in the positive electrode active material as it functions in a lithium secondary battery.

In an embodiment, a specific surface area of the positive electrode active material for a lithium secondary battery can be 1 to 30 m²/g. Specifically, the specific surface area can be 5 to 10 m²/g.

When the specific surface area exceeds the upper limit value of the above range, a large amount of empty space is generated between the secondary particles formed by aggregation of the primary particles. When the specific surface area falls below the lower limit value of the above range, the primary particles are too densely aggregated to form secondary particles.

In some embodiments, the positive electrode active material for a lithium secondary battery can be a lithium-nickel composite oxide satisfying the following Chemical Formula 1:

Liₓ[Ni_{y}CO_{z}Mn_{w}Mᵥ]O₂ <Chemical Formula 1>

wherein M is one or more selected from Ba, Ca, Zr, Ti, Mg, Ta, Nb, and Mo, and wherein 0.9<x<1.2, 0.8<y<1, 0<z<0.8, 0<w<0.05, and 0≤v≤0.2.

### Preparative Methods for Positive Electrode Active Materials

According to still other embodiments of the present disclosure, a method for producing a positive electrode active material can comprise charging a reactor vessel with an aqueous solution containing a sodium- or potassium-based material; adding a) a metal salt aqueous solution containing at least one or more of nickel, cobalt, and manganese, b) a complex ion forming agent, and c) a pH adjuster to the reactor vessel to prepare a reaction solution; filtering the reaction solution to provide a solid metal composite hydroxide; mixing the solid metal composite hydroxide and a lithium raw material to yield a positive electrode active material precursor; and sintering the positive electrode active material precursor.

In the initial step of charging the reactor vessel with the aqueous solution containing the sodium- or potassium-based material, as the sodium- or potassium-based material, at least one of sodium sulfate (Na₂SO₄), sodium chlorate (NaClO₃), potassium sulfate (K₂SO₄), and potassium chlorate (KClO₃) can be used. For example, the sodium-based material can be sodium sulfate (Na₂SO₄).

In some embodiments, the initial aqueous solution containing the sodium- or potassium-based material may contain the sodium- or potassium-based material in an amount of 5 to 10 parts by weight with respect to 100 parts by weight of water. When the sodium or potassium-based material is contained in the range described above, there is an advantage in that the primary particles become thicker. When the salt concentration value exceeds the upper limit value of the above range, the thickness of the primary particle increases significantly. When the salt concentration value falls below the lower limit value of the above range, the thickness of the primary particle decreases significantly.

When the initial conditions are formed in the reactor vessel using the aqueous solution of the sodium- or potassium-based material rather than water or an aqueous ammonium salt solution, the primary particles of the resulting positive electrode active material precursor tend to be thicker and larger, and crystals of the positive electrode active material produced using the initial sodium- or potassium-based aqueous solution, in particular an aqueous sodium sulfate solution to produce the precursor are more uniform and exhibit the form of a single crystal.

In the adding of a) the metal salt aqueous solution containing at least one or more of nickel, cobalt, and manganese, b) the complex ion forming agent, and c) the pH adjuster into the reactor vessel to form the reaction solution, the metal salt aqueous solution, the complex ion forming agent, and the pH adjuster can be added in the above-described order at predetermined time intervals or can be injected simultaneously. These solutions can be added in any convenient manner, such as dropwise by addition funnel(s) or by injection using a syringe.

In the adding of the metal salt aqueous solution containing at least one or more of nickel, cobalt, and manganese, the complex ion forming agent, and the pH adjuster into the reactor vessel, the metal salt aqueous solution can include acetate, nitrate, sulfate, halide, sulfide, hydroxide, carbonate, oxalate, oxide, and/or oxyhydroxide anions in combination with at least one of nickel, cobalt and manganese cations. As a non-limiting example, the metal salt aqueous solution containing nickel can be Ni(OH)₂, NiO, NiOOH, NICO₃·2Ni(OH)₂·4H₂O, NiC₂O₄·2H₂O, Ni(NO₃)₂·6H₂O, NiSO₄, NiSO₄·6H₂O, a fatty acid nickel salt, nickel halide, or a combination thereof.

As a non-limiting example, the metal salt aqueous solution containing cobalt can be Co(OH)₂, CoOOH, Co(OCOCH₃)₂·4H₂O, Co(NO₃)₂·6H₂O, CoSO₄, Co(SO₄)₂·7H₂O, or a combination thereof. As a non-limiting example, the metal salt aqueous solution containing manganese can be Mn₂O₃, MnO₂, Mn₃O₄, MnCO₃, Mn(NO₃)₂, MnSO₄, manganese acetate, manganese dicarboxylate, manganese citrate, a fatty acid manganese salt, manganese oxyhydroxide, manganese chloride, or a combination thereof.

In the step of adding the metal salt aqueous solution containing at least one or more of nickel, cobalt, and manganese, the complex ion forming agent, and the pH adjuster to the reactor vessel to form the reaction solution, the complex ion forming agent may form a complex with at least one ion of nickel, cobalt, and manganese.

In some embodiments, in the step of adding the metal salt aqueous solution containing at least one or more of nickel, cobalt, and manganese, the complex ion forming agent, and the pH adjuster to the reactor vessel to form the reaction solution, where these solutions are added in separate streams to the reactor vessel, where a total metal salt concentration in the metal salt aqueous solution is about 2.5M, where the complex forming agent is ammonia, and where the ammonia is added to the reactor vessel as a 28% ammonia water solution, a ratio of a flow rate of the ammonia water solution to a flow rate of the metal salt aqueous solution can be in a range of about 0.06 to about 0.3. Specifically, the ratio of the flow rate of the ammonia water to the flow rate of the metal salt aqueous solution can be 0.1 to 0.2.

When the flow rate of the metal salt aqueous solution falls within the above range, a positive electrode active material having a single particle shape can be produced. When the flow rate is outside the above range, a positive electrode active material having a single particle shape cannot be realized.

In some embodiments, in the step of adding the metal salt aqueous solution containing at least one or more of nickel, cobalt, and manganese, the complex ion forming agent, and the pH adjuster into the reactor vessel to form the reaction solution, a pH in the reactor can be controlled to a range of about 10 to about 12, and specifically, 10.5 to 11.5.

In some embodiments, the sintering of the positive electrode active material precursor can be performed in a temperature range of about 750 to about 1,100 °C. Specifically, the sintering can be performed at 800 to 1,000 °C, and more specifically, 780 to 950 °C. When the sintering is performed in the above temperature range, the primary particles are grown thickly without nuclear aggregation, such that a positive electrode active material having a single particle shape can be produced.

In some embodiments, the sintering of the positive electrode active material precursor can be performed for about 5 to about 30 hours. Specifically, the sintering can be performed for 8 to 12 hours.

### Lithium Secondary Batteries

According to still other embodiments of the present disclosure, there is provided a lithium secondary battery including a positive electrode including the positive electrode active material described above; a negative electrode; and an electrolyte.

The positive electrode includes a current collector and a positive electrode active material layer positioned on the current collector. The positive electrode active material layer can include a positive electrode active material, and the positive electrode active material can include the above-described positive electrode active material for a lithium secondary battery according to an embodiment. In the positive electrode active material layer, a content of the positive electrode active material can be 90 wt % to 99 wt % with respect to the total weight of the positive electrode active material layer.

The positive electrode active material layer can further include a binder and/or a conductive material. In this case, a content of each of the binder and the conductive material may be 1 wt % to 5 wt % with respect to the total weight of the positive electrode active material.

The binder can serve to attach positive electrode active material particles well to each other and also to attach the positive electrode active material to the current collector well. Representative examples of the binder can include, but are not limited to, polyvinyl alcohol, carboxymethyl cellulose, hydroxypropyl cellulose, diacetyl cellulose, polyvinyl chloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, and nylon.

The conductive material can be used for imparting conductivity to the electrode. Any electronic conductive material may be used as long as it does not cause chemical changes in a battery to be configured. Examples of the conductive material can include a carbon-based material such as natural graphite, artificial graphite, carbon black, acetylene black, Ketjen black, or carbon fibers; a metallic material such as metal powder or metal fibers such as copper, nickel, aluminum, or silver; a conductive polymer such as a polyphenylene derivative; and a conductive material including a mixture thereof.

As the positive electrode current collector, an aluminum foil, a nickel foil, or a combination thereof can be used, but is not limited thereto.

The negative electrode can include a current collector and a negative electrode active material layer formed on the current collector, and the negative electrode active material layer can include a negative electrode active material.

The negative electrode active material can include a material capable of reversibly intercalating and deintercalating lithium ions, a lithium metal, a lithium metal alloy, a material capable of doping and dedoping lithium, or a transition metal oxide.

As the material capable of reversibly intercalating and deintercalating lithium ions, any carbon-based negative electrode active material that is generally used in a lithium ion secondary battery can be used as a carbon material, and representative examples thereof include crystalline carbon, amorphous carbon, and a combination thereof.

As the lithium metal alloy, an alloy of lithium and a metal selected from the group consisting of Na, K, Rb, Cs, Fr, Be, Mg, Ca, Sr, Si, Sb, Pb, In, Zn, Ba, Ra, Ge, Al, and Sn can be used.

Examples of the material capable of doping and dedoping lithium can include Si, SiOₓ (0<x<2), a Si—Y alloy (Y is an element selected from the group consisting of an alkali metal, an alkaline earth metal, a group 13 element, a group 14 element, a transition metal, a rare earth element, and a combination thereof, but not Si), Sn, SnO₂, and Sn—Y (Y is an element selected from the group consisting of an alkali metal, an alkaline earth metal, a group 13 element, a group 14 element, a transition metal, a rare earth element, and a combination thereof, not Sn).

Examples of the transition metal oxide can include vanadium oxide and lithium vanadium oxide. The negative electrode active material layer can also include a binder and can optionally further include a conductive material.

The binder can serve to attach negative electrode active material particles well to each other and also to attach the negative electrode active material to the current collector well.

The conductive material can be used for imparting conductivity to the electrode. Any electronic conductive material can be used as long as it does not cause chemical changes in a battery to be configured.

The current collector can be selected from the group consisting of a copper foil, a nickel foil, a stainless steel foil, a titanium foil, nickel foam, copper foam, a polymer substrate coated with a conductive metal, and a combination thereof.

The negative electrode and the positive electrode can be manufactured by mixing the active materials, the conductive material, and the binder in a solvent to prepare active material compositions and applying the compositions to the current collectors, respectively. Since such an electrode manufacturing method is widely known in the art, a detailed description thereof is omitted in the present specification. As the solvent, N-methylpyrrolidone and the like can be used, but are not limited thereto.

The electrolyte can include a non-aqueous organic solvent and a lithium salt.

The non-aqueous organic solvent can serve as a medium through which ions involved in the electrochemical reaction of the battery can move.

The lithium salt can be dissolved in the organic solvent, can act as a supply source of the lithium ions in the battery to allow a basic operation of the lithium secondary battery, and can serve to promote movement of the lithium ions between the positive electrode and the negative electrode.

Depending on the type of lithium secondary battery, a separator can be placed between the positive electrode and the negative electrode. As the separator, a polyethylene, polypropylene, or polyvinylidene fluoride layer or a multilayer film of two or more layers thereof can be used, and a mixed multilayer film such as a polyethylene/polypropylene double-layered separator, a polyethylene/polypropylene/polyethylene triple-layered separator, or a polypropylene/polyethylene/polypropylene triple-layered separator can also be used.

The lithium secondary battery may be classified as a lithium ion battery, a lithium ion polymer battery, or a lithium polymer battery depending on the types of separator and electrolyte used, may be classified into cylindrical, prismatic, coin, or pouch types depending on the shape thereof, and may be classified into a bulk type or a thin film type, depending on the size thereof. The structures and manufacturing methods for these batteries are widely known in the art, and detailed descriptions will be omitted.

### EXAMPLES

Hereinafter, preferred examples and comparative examples of the present disclosure are described. However, each of the following examples is merely a preferred example of the present disclosure, and the present disclosure is not limited to the following examples.

### Method of Preparing Positive Electrode Active Material Precursor for Lithium Secondary Battery

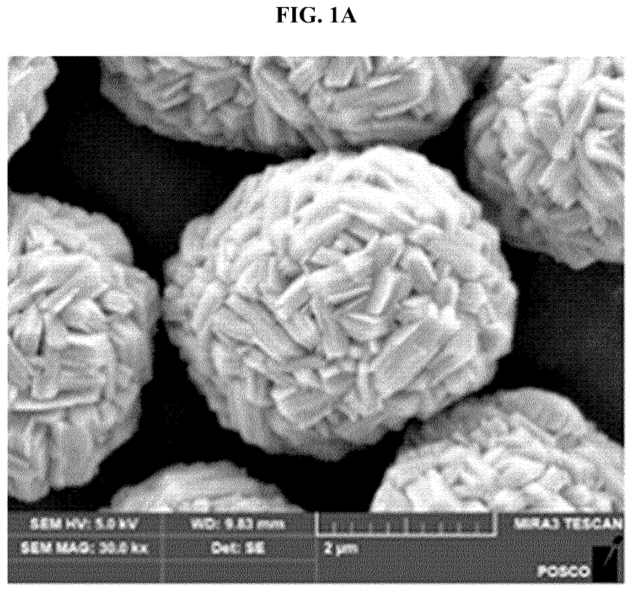

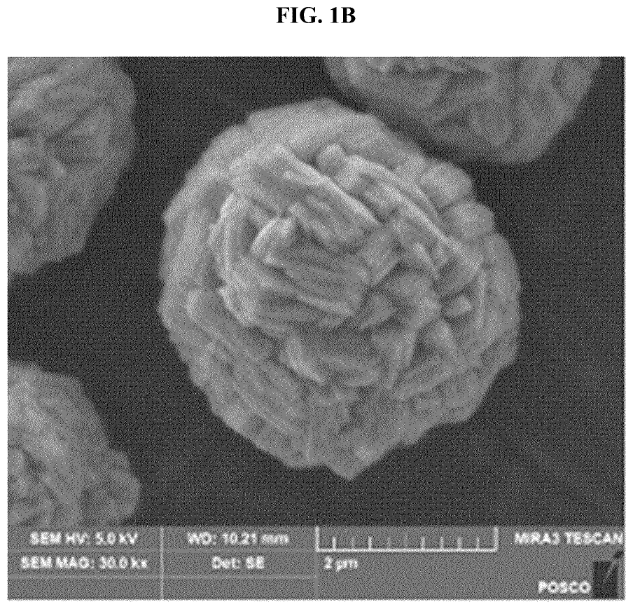

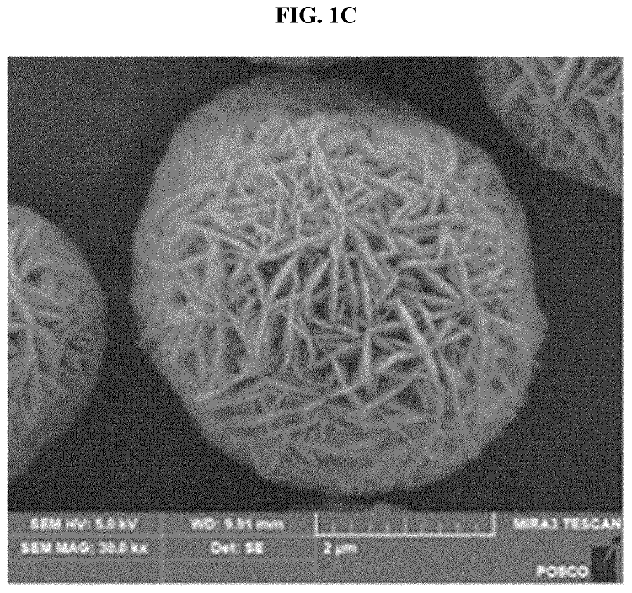

FIGS. 1A to 1C illustrate SEM photographs of positive electrode active material precursors according to examples and comparative examples of the present disclosure.

FIGS. 1A, 1B, and 1C illustrate SEM photographs of positive electrode active material precursors prepared by Example 1, Example 2, and Comparative Example 1 described below, respectively. FIGS. 1A to 1C show that the positive electrode active material precursors prepared by Examples 1 and 2 of the present disclosure tend to be thick and large.

### Example 1

Water was introduced into a 100 L batch reactor in an amount of 15% of the total volume of the reactor, and then sodium sulfate was introduced into the reactor in an amount of 5 parts by weight with respect to 100 parts by weight of water. Thereafter, the internal temperature was set to 30 to 50 °C while stirring at a speed of 400 rpm, and nitrogen gas was introduced into the reactor to form an inert atmosphere. Thereafter, a 2.5 M metal sulfate aqueous solution in which nickel sulfate, cobalt sulfate, and manganese sulfate were mixed in a molar ratio of 0.8:0.1:0.1, and 25% sodium hydroxide, and 28% ammonia water were prepared.

A flow rate of the metal sulfate aqueous solution was controlled to 3 L/hr, a flow rate of the ammonia water was controlled to a ratio of 0.1 relative to the flow rate of the metal sulfate aqueous solution, and the amount of sodium hydroxide (NaOH) solution introduced was controlled so that a hydrogen ion concentration (pH) in the reactor was about 11.0 to 12.0.

Thereafter, a reactant was introduced so that a stirring speed was 500 rpm and an average residence time of the entire solution was 20 hours, a reaction temperature was maintained at 40 to 70 °C, nitrogen gas was introduced, and then, the inert atmosphere was maintained. After the reaction was completed, the formed solution was washed and solid-liquid separated using a filter press, and the remaining moisture was removed using high-pressure fresh air. The solid-liquid separated active material was dried at 100 to 200 °C using a fluidized bed dryer.

Lithium hydroxide was mixed with the hydroxide particles obtained by the above-described method so that an equivalent ratio relative to the hydroxide was 1.05, thereby preparing a positive electrode active material precursor.

### Example 2

Water was introduced into a 100 L batch reactor in an amount of 15% of the total volume of the reactor, and then sodium sulfate was introduced into the reactor in an amount of 10 parts by weight with respect to 100 parts by weight of water. Thereafter, the internal temperature was set to 30 to 50 °C while stirring at a speed of 400 rpm, and nitrogen gas was introduced into the reactor to form an inert atmosphere. Thereafter, a 2.5 M metal sulfate aqueous solution in which nickel sulfate, cobalt sulfate, and manganese sulfate were mixed in a molar ratio of 0.8:0.1:0.1, and 25% sodium hydroxide, and 28% ammonia water were prepared.

A flow rate of the metal sulfate aqueous solution was controlled to 3 L/hr, a flow rate of the ammonia water was controlled to a ratio of 0.2 relative to the flow rate of the metal sulfate aqueous solution, and the amount of sodium hydroxide (NaOH) solution introduced was controlled so that a hydrogen ion concentration (pH) in the reactor was about 11.5 to 12.5.

Thereafter, a reactant was introduced so that a stirring speed was 400 rpm and an average residence time of the entire solution was 20 hours, a reaction temperature was maintained at 40 to 70 °C, nitrogen gas was introduced, and then, the inert atmosphere was maintained. After the reaction was completed, the formed solution was washed and solid-liquid separated using a filter press, and the remaining moisture was removed using high-pressure fresh air. The solid-liquid separated active material was dried at 100 to 200 °C using a fluidized bed dryer.

Lithium hydroxide was mixed with the hydroxide particles obtained by the above-described method so that an equivalent ratio relative to the hydroxide was 1.05, thereby preparing a positive electrode active material precursor.

### Comparative Example 1

The same procedure as that of Example 1 was performed, except that water was introduced into the 100 L batch reactor in an amount of 15% with respect to the total volume of the reactor and sodium sulfate was not additionally introduced.

### Evaluation Examples—Characteristics of Precursor

Table 1 shows XRD characteristics and single crystals of the precursors according to Examples 1 and 2 and Comparative Example 1.

The XRD characteristics were measured using SMARTLAB equipment available from Rigaku Corporation.

TABLE 1

| | XRD characteristics | | | | | | | | | |
|---|---|---|---|---|---|---|---|---|---|---|
| Experimental | I₀₀₁/I₁₀₀ | I₀₀₁/I₁₀₁ | I₀₀₁/I₁₀₂ | I₀₀₁/I₁₁₀ | I₀₀₁/I₁₁₁ | I₁₀₀/I₀₀₁ | I₁₀₀/I₁₀₁ | I₁₀₀/I₁₀₂ | I₁₀₀/I₁₁₀ | I₁₀₀/I₁₁₁ |
| Example | — | — | — | — | — | — | — | — | — | — |
| Example 1 | 4.4 | 1.5 | 4.9 | 10.3 | 13.0 | 0.23 | 0.34 | 1.13 | 2.37 | 2.98 |
| Example 2 | 2.3 | 1.8 | 6.7 | 4.2 | 7.4 | 0.44 | 0.78 | 2.95 | 1.83 | 3.28 |
| Comparative | 0.3 | 0.5 | 2.4 | 1.1 | 1.7 | 3.11 | 1.56 | 7.40 | 3.30 | 5.31 |
| Example 1 | | | | | | | | | | |

| | Full width at half maximum | | | | | Particle diameter | | | |
|---|---|---|---|---|---|---|---|---|---|
| | 001 | 100 | 101 | 102 | 110 | characteristics | | | |
| Experimental | plane | plane | plane | plane | plane | D10 | D50 | D90 | |
| Example | ° | ° | ° | ° | ° | μm | μm | μm | Span |
| Example 1 | 0.27 | 0.34 | 0.37 | 0.56 | 0.66 | 2.86 | 3.82 | 5.41 | 0.67 |
| Example 2 | 0.42 | 0.21 | 0.55 | 1.03 | 0.33 | 3.09 | 4.06 | 5.58 | 0.61 |
| Comparative | 3.13 | 2.89 | 0.35 | 2.11 | 3.15 | 3.18 | 4.5 | 6.68 | 0.78 |
| Example 1 | | | | | | | | | |

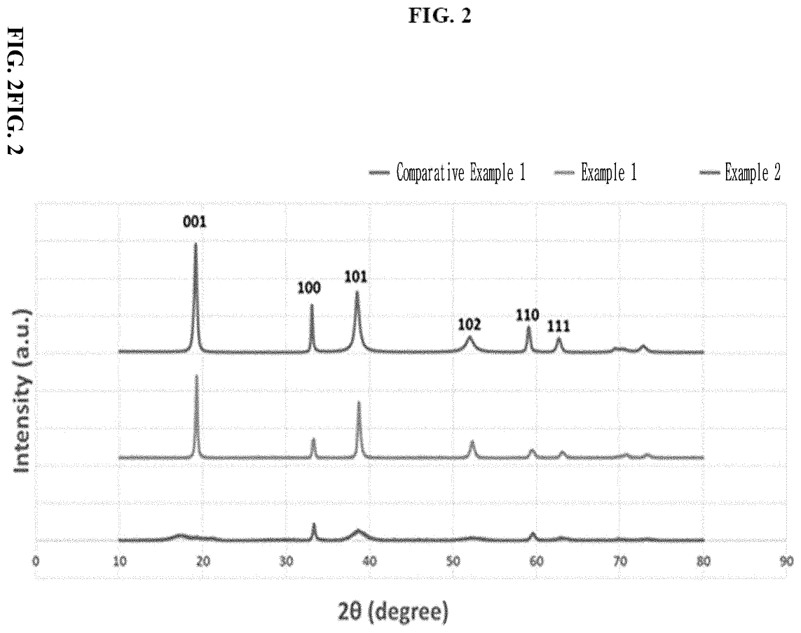

FIG. 2 illustrates XRD peak intensity values according to examples and comparative examples of the present disclosure.

Referring to FIG. 2, it may be confirmed that the resulting values of Examples 1 and 2 are included in the XRD peak intensity value range of the present disclosure, whereas the resulting value of Comparative Example 1 is not included in the XRD peak intensity value range of the present disclosure.

### Examples 3 and 4 and Comparative Example 2—Positive Electrode Active Material

The positive electrode active material precursors formed by Examples 1 and 2 and Comparative Example 1 were heated at a heating rate of 2.5 °C/min in an oxygen atmosphere and then sintered at 780 °C for 9 hours, thereby producing lithium composite metal oxides having a uniform single crystal structure.

### Evaluation Examples—Particle Surface Analysis of Positive Electrode Active Material for Lithium Battery Having Single Crystal Structure and Coin Cell Evaluation

Table 2 shows particles surface analysis and coin cell evaluation according to the content of the complex ion forming agent according to each of Examples 3 and 4 and Comparative Example 2.

For the coin cell evaluation, a coin cell type (CR2032) half cell (coin cell) was assembled in a moisture-controlled dry room, and after cell assembly, the coin cell was aged at room temperature for 2 hours to achieve electrolyte impregnation and electrochemical equilibrium.

The coin cell was evaluated using a TOSCAT-3100 cycler. First, formation was performed by charging and discharging the coin cell for one cycle by applying a current density of 0.1 C in a voltage range of 2.5 V to 4.25 V, and then charging and discharging the coin cell by applying a current density of 0.3 C in the same voltage range. The initial discharge capacity and Coulombic efficiency (C efficiency) in the formation, and the capacity retention rate during the evaluation at a high temperature as a high-temperature capacity retention rate are shown in the following table.

TABLE 2

| | Complexing agent | | [Ammonia | | | | 0.1 C | | High- |
|---|---|---|---|---|---|---|---|---|---|
| | | Complex ion | water flow | | | | discharge | 0.1 C | temperature |
| | | forming | rate]/[metal | | | | capacity | efficiency | capacity |
| | Water | agent content | salt aqueous | | | | at room | at room | retention |
| Experimental | [parts by | [parts by | solution flow | LiOH | Li₂CO₃ | LiOH/ | temperature | temperature | rate [after |
| Example | weight] | weight] | rate] ratio | [ppm] | [ppm] | Li₂CO₃ | [mAh/g] | [%] | 30 cycles/%) |
| Example 3 | 100 | 5 | 0.1 | 2000 | 1800 | 1.11 | 204.22 | 89.3 | 96.2 |
| Example 4 | 100 | 10 | 0.2 | 1400 | 800 | 1.75 | 205.64 | 89.9 | 96.7 |
| Comparative | | — | 0.05 | 4200 | 2100 | 2.00 | 20.34 | 88.9 | 95.8 |
| Example 2 | | | | | | | | | |

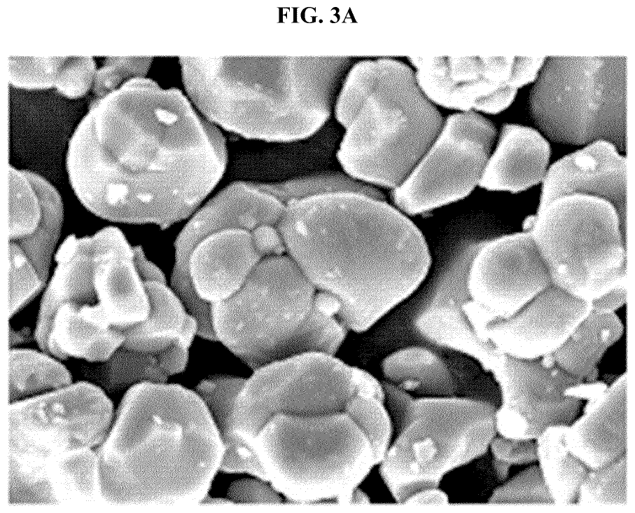

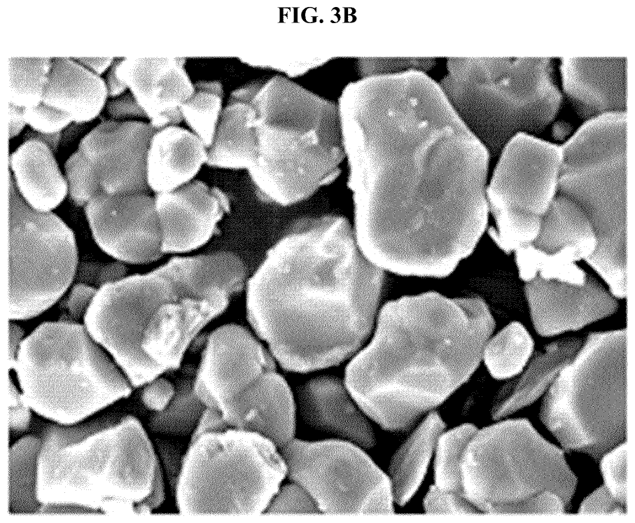

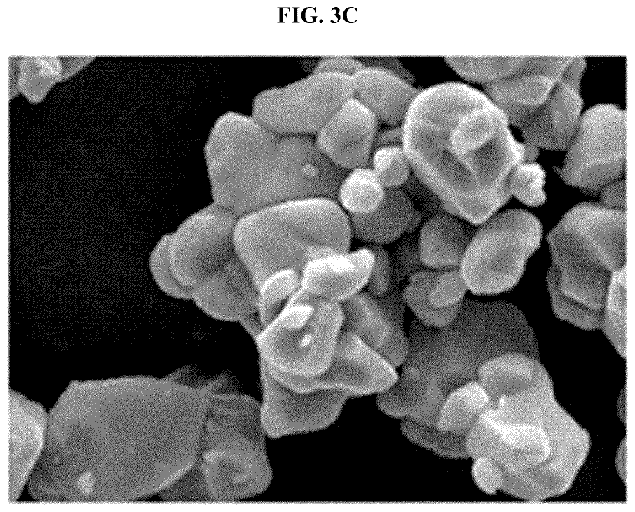

FIGS. 3A to 3C illustrate SEM photographs obtained by imaging positive electrode active materials for a lithium secondary battery according to examples and comparative examples of the present disclosure.

FIGS. 3A to 3C show the positive electrode active materials of Example 3, Example 4, and Comparative Example 2, respectively, and it may be confirmed that a more uniform single crystal form is exhibited in Examples 3 and 4 compared to Comparative Example 2.

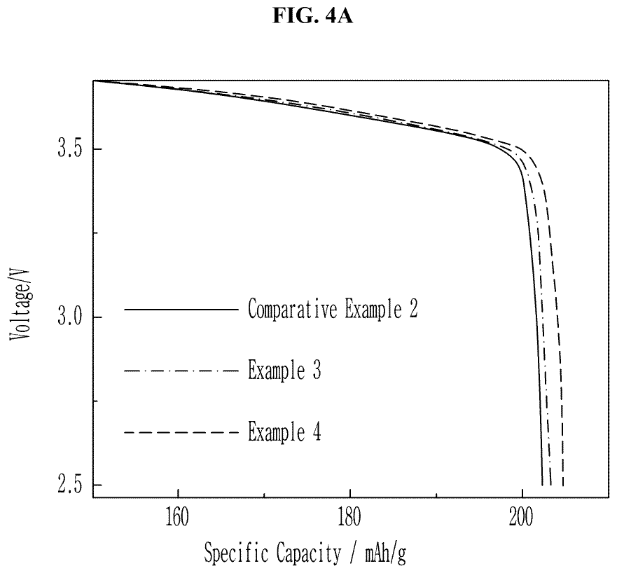

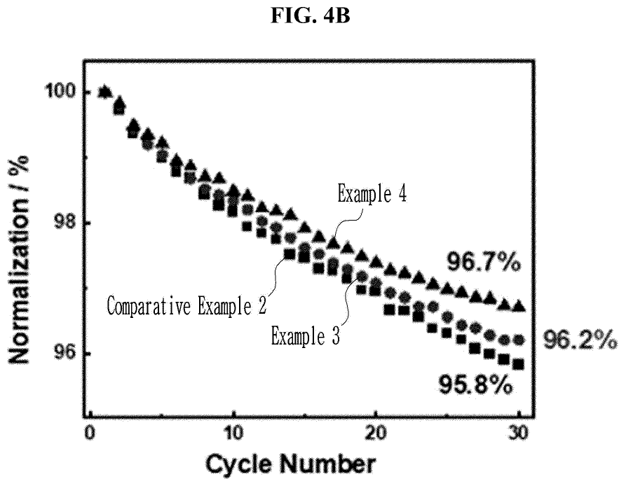

FIGS. 4A and 4B are graphs showing capacity characteristics and lifespan characteristics of the positive electrode active materials for a lithium secondary battery according to examples and comparative examples of the present disclosure.

According to FIGS. 4A and 4B, it may be confirmed that the positive electrode active materials of Examples 3 and 4 have more excellent capacity characteristics and lifespan characteristics compared to Comparative Example 2.

### Evaluation Examples—Properties of Sodium Sulfate as Complex Ion Forming Agent

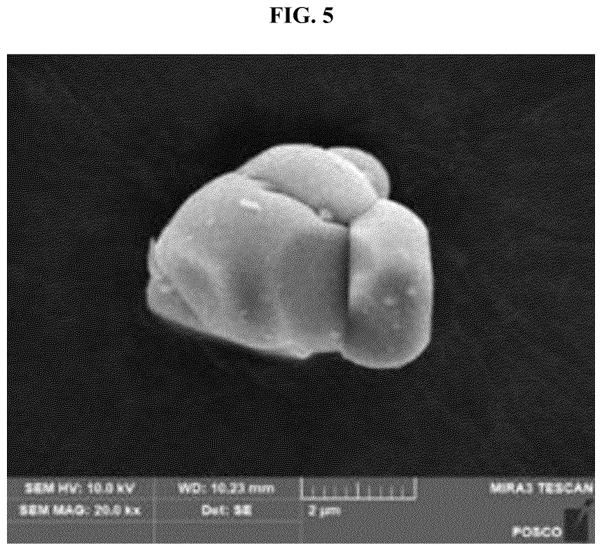

FIG. 5 illustrates an SEM photograph of an active material precursor for a lithium secondary battery prepared by adding ammonium sulfate in a comparative example of the present disclosure.

FIG. 5 illustrates an SEM photograph of an active material precursor for a lithium secondary battery prepared by adding ammonium sulfate to a reactor. FIGS. 1A and 1B are SEM photographs of the positive electrode active material precursors prepared using sodium sulfate as an initial reaction condition, and FIG. 5 is an SEM photograph of the positive electrode active material precursor prepared using sodium sulfate as an initial reaction condition.

Referring to FIGS. 1A, 1B, and 5, it may be confirmed that the primary particles of FIGS. 1A and 1B, which are the precursors prepared by adding sodium sulfate, tend to be thicker and larger than the precursor of FIG. 5 prepared by adding ammonium sulfate. In addition, it may be confirmed that it is preferable to use sodium sulfate as one of the initial reaction conditions rather than ammonium sulfate, as the crystals of the material using sodium sulfate are more uniform and show the form of a single crystal.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

1. A positive electrode active material precursor, wherein the positive electrode active material precursor comprises nickel, cobalt, manganese and oxygen atoms, wherein the positive electrode active material precursor satisfies, in X-ray diffraction (XRD) peak values, at least one of an I₀₀₁/I₁₀₀ ratio of 0.5 to 6, an I₀₀₁/I₁₀₁ ratio of 0.6 to 3, an I₀₀₁/I₁₀₂ ratio of 2.5 to 8, an I₀₀₁/I₁₁₀ ratio of 1.5 to 11, an I₀₀₁/I₁₁₁ ratio of 2 to 14, an I₁₀₀/I₀₀₁ ratio of 0.1 to 3.1, an I₁₀₀/I₁₀₁ ratio of 0.1 to 1.5, an I₁₀₀/I₁₀₂ ratio of 1.0 to 7.3, an I₁₀₀/I₁₁₀ ratio of 1.5 to 3.2, and an I₁₀₀/I₁₁₁ ratio of 2.5 to 5.3, and
wherein, in the XRD peak values, I₀₀₁ is a peak intensity value within a diffraction range of 18.5±1.0°, I₁₀₀ is a peak intensity value within a diffraction range of 33.0±1.0°, I₁₀₁ is a peak intensity value within a diffraction range of 38.5±1.5°, I₁₀₂ is a peak intensity value within a diffraction range of 52.5±1.5°, I₁₁₀ is a peak intensity value within a diffraction range of 59±1.5°, and I₁₁₁ is a peak intensity value within a diffraction range of 63±1.0°.

2. The positive electrode active material precursor of claim 1, wherein:
the positive electrode active material precursor satisfies at least one of a full width at half maximum (FWHM) of a diffraction peak on a (001) plane of 0.1 to 3.0 degrees, a full width at half maximum of a diffraction peak on a (100) plane of 0.1 to 2.8 degrees, a full width at half maximum of a diffraction peak on a (101) plane of 0.36 to 1.0 degrees, a full width at half maximum of a diffraction peak on a (102) plane of 0.1 to 2.0 degrees, and a full width at half maximum of a diffraction peak on a (110) plane of 0.1 to 3.0 degrees.

3. The positive electrode active material precursor of claim 1, wherein:
the positive electrode active material precursor has a structure in which at least one or more layers of a transition metal layer and an oxygen layer are stacked.

4. The positive electrode active material precursor of claim 3, wherein:
the transition metal layer and the oxygen layer form a stacked aggregate through hydrogen bonds.

5. The positive electrode active material precursor of claim 4, wherein:
the positive electrode active material precursor includes at least one or more primary particles, and
a lattice constant value of a c-axis of the at least one or more primary particles is 300 nm to 700 nm.

6. A positive electrode active material prepared by sintering at least one or more positive electrode active material precursors having hydrogen bonds in a <001> direction,
wherein the positive electrode active material is a single particle containing, by wt %, 500 to 2,000 ppm of Li₂CO₃.

7. The positive electrode active material of claim 6, wherein:
the positive electrode active material further contains LiOH, and
0.5≤[LiOH]/[Li₂CO₃]≤1.9,
wherein [LiOH] represents a content of LiOH, [Li₂CO₃] represents a content of Li₂CO₃ and [LiOH]/[Li₂CO₃] represents a molar ratio of LiOH to Li₂CO₃.

8. The positive electrode active material of claim 6, wherein:
LiOH is contained in an amount of about 1,000 to about 4,000 ppm in terms of wt %.

9. The positive electrode active material of claim 6, wherein:
a median particle diameter (D50) of the positive electrode active material is in a range from about 2 to about 20 μm.

10. The positive electrode active material of claim 6, wherein:
a specific surface area of the positive electrode active material is in a range from about 1 to about 30 m²/g.

11. The positive electrode active material of claim 6, wherein:
the positive electrode active material is a lithium-nickel composite oxide represented by the following Chemical Formula 1:
Liₓ[Ni_{y}CO_{z}Mn_{w}Mᵥ]O₂ <Chemical Formula 1>
wherein M is one or more selected from Ba, Ca, Zr, Ti, Mg, Ta, Nb, and Mo,
and wherein 0.9<x<1.2, 0.8<y<1, 0<z<0.8, 0<w<0.05, and 0≤v≤0.2.

12. A method for producing a positive electrode active material, the method comprising:
charging a reactor vessel with an aqueous solution containing a sodium- or potassium-based material in a concentration of 5 to 10 parts by weight with respect to 100 parts by weight of water;
adding a) a metal salt aqueous solution containing at least one or more of nickel, cobalt, and manganese, b) a complex ion forming agent, and c) a pH adjuster to the reactor vessel to prepare a reaction solution;
filtering the reaction solution to provide a solid metal composite hydroxide;
mixing the solid metal composite hydroxide and a lithium raw material to yield a positive electrode active material precursor; and
sintering the positive electrode active material precursor.

13. The method of claim 12, wherein:
the sodium or potassium-based material includes at least one of sodium sulfate, sodium chlorate, potassium chlorate, and potassium sulfate.

14. The method of claim 12, wherein in the adding step,
the metal salt aqueous solution containing at least one or more of nickel, cobalt, and manganese, the complex ion forming agent and the pH adjuster are added in separate streams to the reactor vessel;
a total metal sulfate concentration in the metal salt aqueous solution is about 2.5M;
the complex forming agent is ammonia and the ammonia is added to the reactor vessel as a 28% ammonia water solution; and
a ratio of a flow rate of ammonia water to a flow rate of the metal salt aqueous solution is about 0.06 to about 0.3.

15. The method of claim 14, wherein:
the flow rate of the metal salt aqueous solution is in a range of about 2.5 to about 3.5 L/hr.

16. The method of claim 12, wherein:
the sintering is performed in a temperature range of about 750 to about 1,10 0 °C.

17. The method of claim 12, wherein:
the sintering is performed for about 5 to about 30 hours.

18. The method of claim 12, wherein:
in the adding step, the pH adjuster is added to the reactor vessel at a rate allowing a pH in the reactor vessel to be controlled to a range of about 10 to about 12.

19. The positive electrode active material precursor of claim 1, wherein the positive electrode active material precursor satisfies, in XRD peak values, at least two of an I₀₀₁/I₁₀₀ ratio of 0.5 to 6, an I₀₀₁/I₁₀₁ ratio of 0.6 to 3, an I₀₀₁/I₁₀₂ ratio of 2.5 to 8, an I₀₀₁/I₁₁₀ ratio of 1.5 to 11, an I₀₀₁/I₁₁₁ ratio of 2 to 14, an I₁₀₀/I₀₀₁ ratio of 0.1 to 3.1, an I₁₀₀/I₁₀₁ ratio of 0.1 to 1.5, an I₁₀₀/I₁₀₂ ratio of 1.0 to 7.3, an I₁₀₀/I₁₁₀ ratio of 1.5 to 3.2, and an I₁₀₀/I₁₁₁ ratio of 2.5 to 5.3.

20. The positive electrode active material precursor of claim 1, wherein the positive electrode active material precursor satisfies, in XRD peak values, each of an I₀₀₁/I₁₀₀ ratio of 0.5 to 6, an I₀₀₁/I₁₀₁ ratio of 0.6 to 3, an I₀₀₁/I₁₀₂ ratio of 2.5 to 8, an I₀₀₁/I₁₁₀ ratio of 1.5 to 11, an I₀₀₁/I₁₁₁ ratio of 2 to 14, an I₁₀₀/I₀₀₁ ratio of 0.1 to 3.1, an I₁₀₀/I₁₀₁ ratio of 0.1 to 1.5, an I₁₀₀/I₁₀₂ ratio of 1.0 to 7.3, an I₁₀₀/I₁₁₀ ratio of 1.5 to 3.2, and an I₁₀₀/I₁₁₁ ratio of 2.5 to 5.3.
